(19) United States
(12) Patent Application Publication
(10) Pub. No.: US 2010/0104942 A1
(43) Pub. Date: Apr. 29, 2010

(54) SUBSTRATE FOR LITHIUM THIN FILM BATTERY

(75) Inventors: Martin Lange, Lokeren (BE); Christophe Degraer, Merelbeke (BE)

Correspondence Address: KAGAN BINDER, PLLC, SUITE 200, MAPLE ISLAND BUILDING, 221 MAIN STREET NORTH, STILLWATER, MN, 55082, US

(73) Assignees: NV Bekaert SA, Zwevegem (BE); Cymbet Corporation, Elk River, MN (US)

(21) Appl. No.: 12/531,833

(22) PCT Filed: Feb. 12, 2008
(86) PCT No.: PCT/EP2008/051641

§ 371 Date: Sep. 17, 2009

(30) Foreign Application Priority Data
Mar. 26, 2007 (EP) 07104861.5

(51) Int. Cl. H01M 10/26; H01M 4/38; H01M 4/40; H01M 4/42; H01M 4/46

(52) U.S. Cl. 429/206; 429/209; 429/221; 429/223; 429/220; 429/231.5; 429/229; 429/231.6

(57) ABSTRACT

When attempting to make a lithium ion-switching device such as a high-efficiency, all-solid state, thin film battery the choice of carrier substrate is all important. As such a substrate must withstand a high temperature under an oxidising atmosphere to crystallise certain layers making up the device, the substrate should not oxidise thereby ruling out most metals. The invention now describes a class of ternary alloys of which the oxidation rate is limited and that are useable to produce thin film batteries on. At least one element with a high affinity to oxygen (Al, Mg, Zn or Si) is present in the alloy. The other two metallic elements reduce the growth of the oxide of this first element. In addition the thus formed oxide scale turns out to be an effective barrier to lithium. Surprisingly, the scale shows nanoscopic voids that allow for sufficient electrical contact with the device layers, thereby eliminating the need for a separate current collector. As the ternary alloy can be made in a flexible foil, it can advantageously be used in a roll-to-roll process.

### TECHNICAL FIELD

The invention relates to the field of lithium ion-switching devices and more in particularly to secondary thin film batteries, having lithium as the mobile ion.

### BACKGROUND ART

Rechargeable batteries—commonly called ‘secondary batteries’—are enjoying increased attention as the miniaturisation of electronic circuitry makes high tech appliances more mobile. As users, we expect those high-tech appliances and the battery that powers it:

to be light in weight,

to keep on operating for a long period of time without the need to recharge

to recharge fast

to be able to recharge many times without the operating period becoming shorter

to be safe (non-explosive, non-flammable).

Of course we don't want to pay too much for the whole system either i.e. the total device must be cost effectively designed and produced. As the rechargeable battery is one of the important costs of the whole, the battery should be likewise cheap.

In the competition of technologies, batteries based on lithium ions are gaining ground as they fulfill many of the above requirements. Within the growing class of lithium ion batteries, the batteries based on solid inorganic electrolytes enjoy particular attention. This is not only for the fact that they are inherently safe, but also because they can achieve a high energy density, can be charged fast and cycled many times. In addition there is the hope that they can be made cheap.

Secondary lithium ion, solid state electrolyte based batteries can be made in thin film form. Such a thin film battery—as shown in FIG. 1—inevitably comprises a substrate 102 on which the battery is built. If the substrate is not conductive, a first current collector 104 must be applied first to the substrate 102. On top of that first current collector, a first electrode 106 is deposited followed by an inorganic solid state electrolyte 108. An optional second electrode material 109 covers part of the electrolyte 108. A current collector 110 collects the charge, which is transferred by leads 112, 114 to the load 116 in case the battery 100 is discharging. The thin films are typically deposited by thin film fabrication processes such as for example, physical or chemical vapour deposition (PVD, CVD), plating, gel-to-sol transforming, atomic layer deposition or other such processes.

One or both of the electrodes must act as a reservoir for lithium atoms. The reservoirs have a different electrochemical potential relative to lithium, which forces the lithium to ionise and travel through the electrolyte to the opposite electrode having a lower electrochemical potential in order to reach thermodynamical equilibrium. Let us assume for the moment that the first electrode 106 acts as the cathode where the lithium is reduced (Li⁺ reverts to Li) when discharging. Hence, electrons flow towards the cathode upon discharging to compensate the reducing reaction making this electrode the positive pole of the power supply upon discharge. Mutatis mutandis, the second electrode then becomes the anode, wherein the lithium oxidises upon discharging. The electrolyte 108 must let the lithium ions pass but must be impermeable to electrons in order for the device not to self-discharge. Hence the electrolyte has a high electron resistivity and a high lithium ion conductivity.

The cathode material is a material wherein the lithium atoms are absorbed or intercalated into the lattice of the material. The material can be amorphous or crystalline. A typical example is lithium cobaltate where the amount of lithium varies from Li_{1/2}CoO₂ in the completely charged state to LiCoO₂ when completely discharged. Crystalline materials are preferred for reaching high specific cell capacities (up to 69 μAh/cm²/μm) and low capacity loss per cycle (see e.g. ‘Characterization of Thin-Film Rechargeable Lithium Batteries with Lithium Cobalt Oxide Cathodes’, B. Wang, J. B. Bates, F. X. Hart, B. C. Sales, R. A. Zuhr, and J. D. Robertson, Journal of the Electrochemical Society, 143 (1996) 3203-3213). In order to obtain the cathode material in a crystalline form high temperatures (higher than 500° C.) are needed either during the deposition of the electrode material or thereafter in a separate annealing step.

This high temperature step excludes the use of materials with a low softening point for use as a substrate. Polymer like materials, even high temperature resistant polymers such as polyimides can not be used. In practise only two major classes remain: substrates of a metal or metal alloy with a high melting point and dielectric materials such as high temperature quartz, silicon wafers, sapphire, alumina or the like.

As the latter tend to be expensive and only lend themselves for batch processing due to their brittleness, the former metallic type of substrates are more preferred for ease of processing as they can be provided on rolls to enable cost effective roll-to-roll processing. However, when using metals or metal alloys new and different problems arise:

As the annealing of the first electrode material normally has to be performed in air or oxygen, a metal oxide layer quickly grows between the substrate and the first electrode material. Metal oxides grow due to the ionic conduction for oxygen of the metal oxide layer. So even when the substrate is covered with a metal oxide layer in order to protect the substrate, oxygen will reach the metal of the substrate during high temperature annealing and the metal oxide layer will further grow.

As lithium is a metal with very high diffusivity and reactivity, a considerable amount of it might diffuse into the substrate, or even react with other elements that are present in the substrate, during the high temperature annealing step causing a decrease of the capacity of the battery.

Both of these phenomena impede the use of a metal foil as such for batteries. The resulting batteries are deficient because the layers do not stick well to the substrate, because the electrode becomes lithium deficient, because the substrate itself becomes brittle due to the oxide growth and/or lithium diffusion or because of a combination of all of the above.

In order to counter these problems several solutions have already been proposed:

One can use a thick 3 to 5 μm non-oxidising metal such as platinum, gold or palladium as a first current collector. However, this will increase the cost of the battery as these materials tend to be expensive.

As an alternative, metals with a high melting temperature such as zirconium and titanium have been proposed in U.S. Pat. No. 6,280,875. Such a high melting temperature goes together with a low oxygen diffusion rate i.e. a slower growth of the oxygen layer. Ultimately only zirconium turns out to be useable.

Coating with a metal nitride layer like e.g. titanium nitride or aluminium nitride as described in U.S. Pat. No. 7,083,877. Such metal nitride layers have a low ion-conductivity for oxygen and are well resistant to high temperatures. Preferably the nitride layer is covered with a metal oxide and/or metal oxynitride layer. The former nitride oxide combination enhances the insulating properties of the layer, the latter nitride oxynitride combination are more resistant to gas and water permeation. A non-oxidising current collector of e.g gold, platinum, indium tin oxide remains necessary, as the nitride, oxynitride or oxide layers are too insulating.

Putting the current collector on top of the first electrode as proposed in U.S. Pat. No. 7,056,620. The current collector then has to be open—like the nerve structure of a leaf—to allow the lithium ions to reach the second electrode. The first electrode is then first deposited on the substrate and subsequently crystallised at high temperature in an air or oxygen atmosphere. After cooling the open collector structure is deposited, that on its turn is covered with the electrolyte. The problem with this approach is that quite an amount of surface area is lost to the open electrode. Hence, the area of the battery must be larger by the amount of electrode area that is covered by the current collector compared to a battery of the conventional structure in order to have the same current output.

Producing high efficiency batteries on metal foils is therefore not straightforward.

### DISCLOSURE OF INVENTION

It is an object of the invention to provide a thin film lithium ion switching devices on a metal substrate. The metal substrate is particularly suited to deposit such a device on. It is a further object of the invention to provide such a substrate without the need of depositing an additional layer to grow the first electrode on. Another object of the invention is to provide a metal foil that forms a lithium impermeable barrier so as to better retain the lithium in the device and to prevent loss of lithium to the substrate. In addition it is an object of the invention to provide such a substrate that also allows for sufficient electrical conduction thereby eliminating the need for an additional current collector. Furthermore, it is an object of the invention to provide a substrate material that gives good adhesion of the first electrode to the substrate and remains flexible at all times.

The thin film ion-switching device according to the invention comprises a substrate, a first electrode partly or wholly covering said substrate, an electrolyte partly or wholly covering said first electrode, a second optional electrode covering a part or all of said electrolyte, and a second current collector in contact with said second electrode or—in option—said electrolyte, but not in contact with the first electrode nor the substrate. Specific of the device is that the substrate comprises a layer that is directly useable as a first current collector. The layer is made of an alloy that comprises three alloy elements each one of them being present in an appreciable amount. With an appreciable amount is meant at least more than 0.5%, preferably more than 1% by weight of the total.

‘Alloy elements’—for the purpose of this application—are either:

Metals i.e. any element out of the groups III to VIII B of the Periodic table of the Elements (columns 3 to 12), including also the ‘poor metals’ Al, Ga, In, TI, Ge, Sn, Pb, Sb, Bi and also the IIA element Mg.

Silicon that is generally not considered to be a metal but has considerable influence on the oxidation of the alloy.

The ionisation reaction of these alloy elements (Meⁿ⁺+n e⇄Me) can be ranked in electrochemical potential with respect to the hydrogen standard electrode and the one of them that has the highest electrochemical potential will be called the first metal and is most noble, the one that is the least noble, has the lowest electrochemical potential and thus has the highest affinity to oxygen, will be called the third metal or will be silicon. This makes the second metal the metal having an intermediate chemical potential between the first and the third. As a ranking of nobility of the metals reference is made to the ‘CRC Handbook of Chemistry and Physics’, 67th edition, page D-151-158. Silicon has a potential of −0.857 V with respect to the standard hydrogen electrode (‘Electrochemistry of Silicon and its Oxides’, Xiaoge Gregory, Zhong, p. 47, ISBN 0306465418, Springer, 2001). By appropriate choice of the alloy elements, an oxide layer forms that acts as a good diffusion barrier to lithium and at the same time still allows for sufficient electrical contact with the first electrode material. An oxide layer that acts as a good barrier to lithium is a layer that is XRD amorphous i.e. lacks grain boundaries along which the lithium could migrate. Electrical contact is ensured through small localised voids—of the order of nanometers—in the scale. By preference the layer is thinner than 200 nm, more preferred is thinner than 100 nm but in any case not thinner than 50 nm.

An attempt to understand the mechanism—without being bound by this hypothesis—for the controlled oxide scale formation can be construed as follows (see e.g. ‘Criteria for the formation of protective Al₂O₃ scales on Fe—Al and Fe—Cr—Al alloys’, Z. G. Zhang, F. Gesmundo, P. Y. Hou, Y. Niu, Corrosion Science 48 (2006) 741-765):

Growth of an oxide scale on a metal can occur via two routes:

either the oxygen will diffuse through the first formed scale towards the alloy and the scale will continue to grow at the scale metal or metal alloy interface i.e. from within. This is called anodic scale growth or internal oxidation. Or,

the metal will diffuse through the first formed scale outwardly to the gas phase interface and the scale will continue to grow on top. This is called cathodic scale growth or external oxidation.

Metal oxide scale growth is governed by the balance of these two diffusion processes. For single metals, one of the two will outbalance the other. In an alloy comprising two or more metals, the number of diffusion processes increases and the oxide scale formation can go through a number of local equilibria before a final growth mechanism is reached. For example when two metals are present in an alloy, both can form their own oxide (each of them inward or outward) and a mixture of both oxides or the spinel of the metals will form. The competition between both oxides can also lead to spatial separation wherein nodules of one oxide form in a field of the other metal oxide. However, the oxide of the one metal with the highest oxygen affinity will prevail provided that enough of that metal is present in that alloy. Hence, a critical concentration of the metal with the highest oxygen affinity must be present before the scale will be dominated by the oxide of that metal.

When now three elements are present in the alloy, the alloy element of the lowest electrochemical potential will first oxidise and form a layer on the substrate. The second metal may reduce the critical concentration needed for establishing a closed external oxide scale of the third alloy element (being a metal or silicon). The second metal prevents, by its own internal oxidation, the continued oxide diffusion into the alloy, so that the internal oxidation of the third alloy element is limited and the external oxidation of the third alloy element will prevail. However, due to the depletion of the upper layer of the third element and the blocking of the second metal oxide, the growth of the third alloy element oxide will be limited. In this manner, the degradation and continued growth of the third alloy element oxide can be limited and even controlled.

Possible choices of alloy elements are:

For the first metal: one out of the group consisting of Fe, Ni, Sn, Cu

For the second metal: one out of the group consisting of Cr, Zn, Fe

For the third element: one out of the group consisting of Mg, Al, Zn, Si.

In each combination the order of nobility must be respected.

A first preferred composition of the alloy is when the first metal is Fe, the second metal is Cr and the third metal is Al. A preferred composition is when more than 3% by weight of Al is present in the alloy. Below this threshold, the aluminium oxide phases do not grow sufficiently dense. Even more preferred is when more than 5% by weight is present. The amount of aluminium is limited to about 7 wt %. Above that number the alloy becomes difficult to work.

The amount of Al needed to form an aluminium oxide scale decreases with increasing amount of Cr. A Cr content of 19 wt. % or more is necessary to support aluminium oxide scale formation when only 5 Wt. % Al is present. The balance of the alloy is made up of iron Fe. Unintentional impurities may be present in concentrations below 0.5 wt. %.

An alternative alloy is Ni—Cr—Al which behaves quite similar to the Fe—Cr—Al described above. Aluminium is then present in at least 3 wt. %, preferably more than 4%. Chromium percentage is above 15%. The balance is made up of nickel and unintentional impurities.

In any case it is believed that the third alloy element must have a high affinity to oxygen. Metals like Al, Mg, Zn, or alternatively Si are therefore more likely candidates to form a good scale than e.g. Cr in Fe—Ni—Cr.

There are however some intentional impurities that have an extreme influence on the morphology of the scale formed. These metals are known as ‘reactive elements’ and are added to the molten alloy at a very late stage of the manufacturing process as they are very oxidising. As an alternative the oxides of these elements can be added to the molten alloy. The resulting solid of the latter is known as an ‘oxide dispersion strengthened (ODS)’ material. These ‘reactive elements’ are one or more metals out of the group comprising yttrium Y, scandium Sc, hafnium Hf, zirconium Zr, cerium Ce and lanthanum La. Their influence on the scale formation is perceptible from concentrations as low as 0.02 wt. %. More than 1.00 wt. % is not needed of these reactive elements.

Although the true mechanism on how these reactive elements influence the oxide scale growth are not yet fully understood, the following is observed (see: The Isothermal Oxidation behaviour of Fe—Cr—Al and Fe—Cr—Al—Y alloys at 1200° C′, F. H. Stott, G. C. Wood and F. Golightly, Corrosion Science, Vol. 19, p 869, and ‘Oxidation behaviour of Kanthal A1 and Kanthal AF at 1173 K: effect of yttrium alloying addition’, R. Cueff, H. Buscail, E. Caudron, C. Issartel, F. Riffard, Applied Surface Science 207(2003) 246-254)

The parabolic growth rate constant of the scale is reduced strongly by the addition of a reactive element,

The compressive stresses on the alumina scale that occur during oxidation of material without reactive elements do not longer occur. This leads to a flat scale without ridges that adheres very well to the base metal and does not exhibit spalling upon bending.

The oxide layer should be thick enough to block the lithium from diffusion out. The inventors estimates that the thickness of the aluminium oxide layer should be somewhere between 10 and 400 nm, more preferred being between 50 and 200 nm. Alternatively, the scale must allow for sufficient electrical contact with the device. Localised nanoscopic (10 to 500 nm) voids have been observed in the scale that probably allow for sufficient electrical contact, although this should at present be considered a non-binding hypothesis.

Such alloys, with the addition of Yttrium, are known as a “Fecralloy®”, and were originally developed by the UK Atomic Energy Authority (Harwell, UK). Various compositions have become available and are known under different tradenames: Aluchrom YHf, Aluchrom I SE, Aluchrom Y (by Thyssen Krupp VDM) or Kanthal AF (by Sandvik), MA956 (by INCO Alloy international) and others. Known Ni—Cr—Al alloys are Haynes® 214™ from Haynes International.

These alloys can be obtained in the form of foils in sizes of 10 to 100 μm that can be processed in a roll-to-roll installation.

However, the idea of using these alloys is not limited to self supporting foils. Indeed, the alloy could also be sputtered onto another low cost carrier (e.g. a stainless steel foil) from a target containing the alloy. A layer with the alloy deposition is thus formed, and the advantageous properties of the alloy are maintained while the cost is reduced. By preference a layer of at least 100 nm is needed for at least the aluminium oxide layer to form. However, a thickness of 1 μm is more preferred in order not to have depletion effects.

As second alternative, the layer could be deposited on e.g. an iron carrier foil by means of hot dip coating through an appropriate molten mixture (e.g. Zn—Al) of the alloy. Alternatively, the metals can be deposited electrolytically on a carrier metal and subsequently diffused in a protective atmosphere.

As a further alternative, the layered stack could also be deposited on a wire of the appropriate alloy composition. As an even further alternative, the battery could be deposited on sintered metal fibre mat made of a Fe—Cr—Al containing alloy (as available from NV Bekaert SA).

Upon this substrate having the contact layer of the advantageous composition a first electrode is deposited. When this first electrode is acting as a cathode during discharge it can be composed out of one material out of the group of lithium cobaltate, lithium manganate, lithium nickelate, lithium nickel manganese oxide, lithium nickel cobalt manganese oxide, lithium nickel cobalt oxide, lithium vanadium oxide, lithium iron phosphate, lithium vanadium phosphate, lithium cobalt vanadium oxide. Most preferred in the field is lithium cobaltate. Alternatively, when the first electrode is an anode during discharge it can be made of lithium titanium oxide or lithium silicon tin oxynitride.

These ceramic type materials in general have a very low conductivity and are therefore difficult to sputter. Even when using RF assisted sputtering, the deposition rates are low. It has therefore been suggested in PCT/EP2006/066776 from the same applicant to use a target with a doping element that is chosen such that it increases the conductivity of the target but can not be found back in the deposited material. However, this method can be used only when the substrate can be heated at an elevated temperature (say above the evaporation or sublimation temperature of the doping element) in order to make the deposited layer substantially free from the doping element. A preferred doping element is silver, although tin, zinc, bismuth, and antimony, can be used equally well.

The use of such a target, having an electrical resistivity of lower than 6000 Ωm, or even lower than 1200 Ωm while even 120 Ωm is considered possible, leads to an increase of a factor 2 to 20 in deposition speed.

The need for having a high temperature to evaporate or sublimate the doping element out of the deposited first electrode material advantageously goes together with the high temperature that is needed for the crystallisation of the first electrode material! Indeed, the main problem solved by the invention is associated with this heating step.

The inventors also found an additional advantage in using this method of deposition in that the doping element will not only evaporate or sublimate but also diffuse into the oxide layer. As the doping element is in general a well conducting metal, it is thought that it will likewise help to increase the conductivity of the oxidised interface between layer and first electrode material. Doping of an oxide can already have substantial influence even when minute concentrations are present. It is believed that concentrations of less than 0.5% by weight or even less than 0.05% can have an influence and that the advantages remain as long as the doping element remains detectable in the interface layer. The detection limit of very advanced techniques such as Secondary Ion Mass Spectroscopy in association with Time-of-Flight isotope detection (SIMS-TOF) is of the order of magnitude of 10⁷to 10¹⁰ atoms per cm² of monolayer. Even then it is believed that the doping element has some influence on the performance of the interface between layer and first electrode.

The further layers of the thin film battery comprise an electrolyte layer made out of one of the compounds out of the group of lithium phosphate, lithium phosphorus oxynitride, lithium niobate, lithium niobium oxynitride, lithium tantalate, lithium tantalum oxynitride, lithium tantalum niobium oxynitride, lithium silicate, lithium aluminum silicate, lithium silicon oxynitride, and lithium silicon phosphorus oxynitride, lithium aluminum fluoride, lithium boron oxynitride, lithium boron phosphorus oxynitride, lithium boron vanadium oxide, lithium boron selenium oxide, lithium silicon phosphorous oxysulfide, lithium silicon phosphate, lanthanum lithium titanate, lanthanum lithium tatantalate, lanthanum lithium niobate, lithium titanium aluminium phosphate, lithium aluminium germanium phosphate, lithium aluminium yttrium phosphate, a lithium silicosulfide, a lithium borosulfide, a lithium aluminosulfide, a lithium phosphosulfide. Lithium phosphorous oxynitride, commonly called LiPON, is the most preferred. This layer is about 0.5 to 3 μm, preferably 1 to 2 μm thick.

On top of this electrolyte, an optional second electrode material is deposited. In case the second electrode is an anode upon discharging, the material is one chosen out of the group comprising lithium, carbon, graphite, tin, silicon, silicon tin, aluminium, silicon tin aluminium, tin antimony, silicon carbon, silicon cobalt carbon, silicon titanium nitride, silicon titanium boride, magnesium silicon. Most preferred is lithium as then the second electrode material is directly compatible with the lithium extracted from the first electrode. A nanometer thin to one micrometer layer of lithium will suffice. Also preferred is graphite or carbon as a second electrode. Then the layer thickness must be thicker in order to absorb the lithium upon charging. A thickness of 0.5 to 3 μm, or 1 to 2 μm will in general be enough. In case the second electrode is a cathode when discharging the following materials can be used: lithium cobaltate, lithium manganate, lithium nickelate, lithium nickel manganese oxide, lithium nickel cobalt manganese oxide, lithium nickel cobalt oxide, lithium vanadium oxide, lithium iron phosphate, lithium vanadium phosphate, lithium cobalt vanadium oxide, lithium titanium oxide, lithium silicon tin oxynitride, vanadium oxide, titanium sulfate. Most preferred is lithium cobaltate. This layer is preferably 0.5 to 3 μm, or 1 to 2 μm thick.

The stack is finished by applying a second current collector on top of the second electrode. Typical material used to this end are gold, platinum, titanium, copper, nickel, chromium, cobalt indium oxide, tin oxide, indium tin oxide (ITO) and other materials.

In the option that there is no second electrode, the second current collector directly covers the electrolyte. In that case the second current collector must be made of a material that does not react with lithium, as the lithium will grow between the electrolyte and the current collector as the battery is being charged. Typical current collectors that can be used for to this end are copper, titanium, chromium, nickel, gold, platinum, palladium, rhodium or ruthenium.

### BRIEF DESCRIPTION OF FIGURES IN THE DRAWINGS

FIG. 1 shows a schematic cross section of a thin film battery.

FIG. 2 shows the results of an XPS analysis of a sample deposited on foil ‘A’.

FIG. 3 shows the performance of a thin film battery made according the invention.

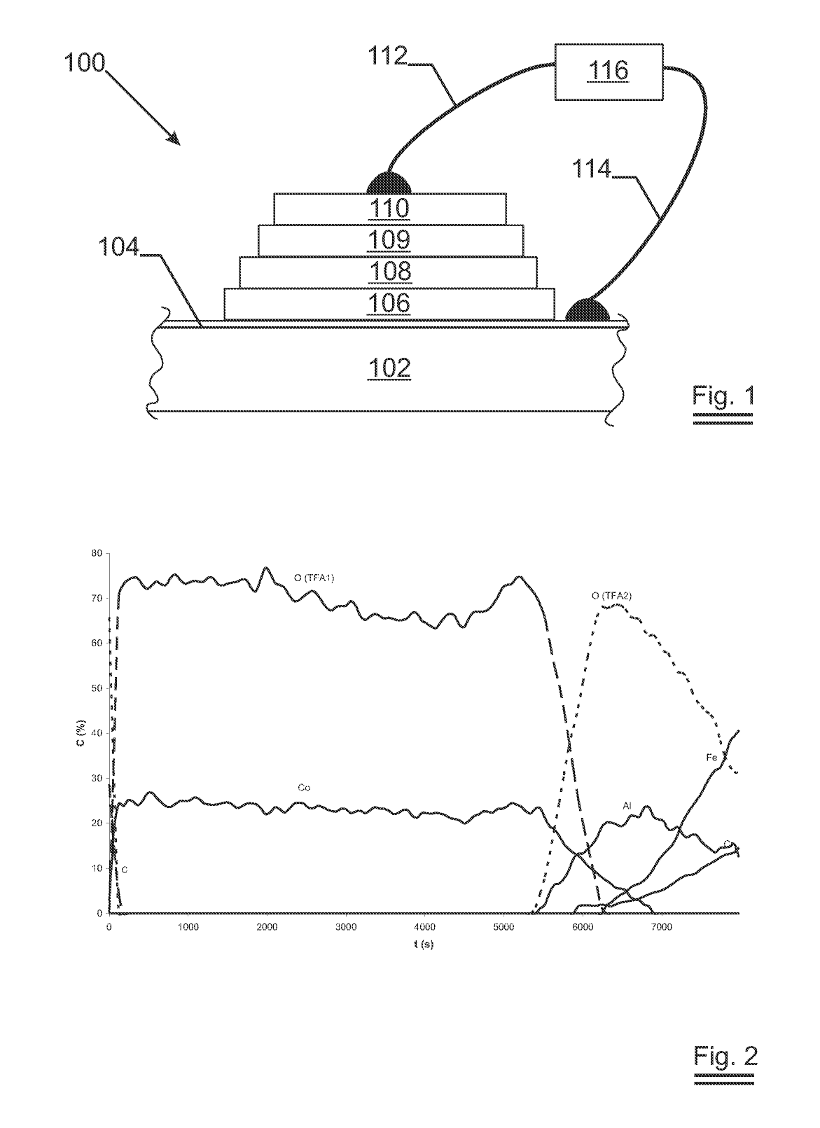

### MODE(S) FOR CARRYING OUT THE INVENTION

On a number of different metal alloy foils a first electrode material was deposited. The following compositions of alloys were selected (in % by weight of the total):

TABLE 1

| Foil | Mat. Nr. | Ni | Cr | Fe | Al | RE | Ph |
|---|---|---|---|---|---|---|---|
| A | DIN 1.4767 | 0.19* | 20.4* | 72.9* | 5.63* | Y ≅ 0.06* | F |
| B | DIN 1.4767 | <0.30 | 19-21 | Bal. | 5.5-6.0 | Zr > 0.03, Hf > 0.03, Y > 0.03 | F |
| C | DIN 1.4767 | <0.30 | 19-21 | Bal. | 5.0-6.0 | 0.15 > La > 0.01 | F |
| D | AISI 301 | 6-9.5 | 16-19 | Bal. | | | A |
| E | AISI 301 | 7.5* | 16.5* | Bal. | | | A |
| F | AISI 302 | 7.2* | 17.2* | Bal. | | | A |
| G | AISI 430 | <0.6 | 16-18 | Bal. | | | F |
| H | AISI 304 | 8-10.5 | 18-20 | Bal. | | | A |

DIN refers to the ‘Werkstoffnummer’,
AISI refers to the ‘American Iron and Steel Institute’.
RE are ‘reactive elements’.
‘<0.30’ means that the element on top of the column is at most the percent in weight indicated,
‘19-21’ means that the element concentration is between 19 and 21 percent by weight of the total,
‘>0.10’ indicates the element is at least the percent in weight indicated.
An asterisk ‘*’ indicates an actually measured value.
‘Bal.’ indicates that - apart from the unintentional impurities - the remainder of the weight is made up by iron.
The column ‘Ph.’ refers to the metallurgical phase the alloy is in: ‘F’ means ‘ferritic’ phase, ‘A’ stands for ‘austenitic’ phase.
Foil ‘A’ and ‘B’ are from the same supplier, but have obtained a different type of rolling treatment.

The foil thickness varied between 50 to 130 μm but is not considered relevant for the invention. The foils were about 5 cm wide. Oil and grease where removed by acetone cleaning prior to coating.

The foils were coated with lithium cobaltate in a roll-to-roll sputter installation. The foil acts as first current collector, while the lithium cobaltate acts as the first electrode material. A lithium cobaltate circular target of diameter 152 mm (6 inch) was used for this. The material was silver doped to a conductivity of about 680 Ωm. Lithium in the target was present slightly above stoichiometry (Li/Co ratio was 1.08). During sputter deposition, the substrate foil was held at a temperature of about 580° C. About 1 kW of DC power was used in the deposition. During sputtering a 60% Ar—40% O₂ process gas was admitted, while the pressure was held at about 0.1 Pa. Each point on the foil remained about 10 minutes under the sputtering plasma while it progressed from pay-off to wind-up station. Note that the layer annealed during sputtering because of the high deposition temperature.

The first electrode materials were characterised in a number of ways: the thickness ‘t’ was determined, the initial roughness R. of the foil according ISO 4287 (the arithmetical mean of the profile over a measuring length) and the roughness Rₐ of the layer after deposition, the Li/Co ratio of the first electrode material and the silver content in the coating relative to the number of cobalt atoms

TABLE 2

| Foil | t (nm) | Rₐ foil (nm) | Rₐ layer (nm) | Li/Co | Ag/Co |
|---|---|---|---|---|---|
| A | 420 | 40-120 | 14.6 | 1.052 | 0.001 |
| B | 398 | 40-120 | 15.8 | 1.105 | 0.001 |
| C | 347 | 220 | 14.0 | 1.061 | 0.002 |
| D | 282 | 30-80 | TR | 0.954 | 0.001 |
| E | 383 | 50-80 | 69.4 | 0.858 | 0.128 |
| F | 305 | 10-20 | TR | 0.714 | 0.066 |
| G | 367 | 10 | 28.3 | 1.114 | 0.042 |
| H | N/A | 30 | N/A | N/A | N/A |

‘TR’ (Too Rough) indicates that the roughness was too high to be measured.
‘N/A’ indicates non-available results.

The roughness measurements learn that there is no correlation between the surface condition of the foil and the roughness of the layer deposited on it. E.g foil ‘F’ has a low roughness of the foil, while the layer deposited on it could not be measured. Oppositely, foil ‘C’ has a high initial roughness, but the layer deposited on it is exceptionally smooth.

The Li/Co ratio should be one or slightly above one for a well performing device. Lower values indicate that some of the lithium was lost in the process. As all samples have been deposited under identical conditions, a loss of lithium can only be attributed to migration of the lithium into the substrate. Foils ‘D’, ‘E’ and ‘F’ all suffer from a lithium deficiency.

The Ag/Co ratio should be as low as possible in the first electrode material. For foils ‘A’, ‘B’, ‘C’ and ‘D’ this is definitely the case, while for foil ‘E’, ‘F’, and ‘C’ the opposite is true.

Finally the crystal structure of the LiCoO₂ was determined through X-ray diffraction (CuKα_{1,2} radiation was used). As discussed in the ‘Background of the invention’ it is of prime importance that the first electrode material is crystallised in order to function well. A crystallised lattice allows optimal intercalation/de-intercalation of the lithium. LiCoO₂ has a layered structure of rhombohedral symmetry (space group R 3̅ m). The most prominent reflecting planes are the (003) and (104) planes. On the deposited layers, the following phases were found back ('cps' is ‘counts per second’):

TABLE 3

| Foil | Dominant XRD peaks |
|---|---|
| A | LiCoO₂: (104) 65 cps, (003) 50 cps |
| B | LiCoO₂: (104) 50 cps, (003) 30 cps |
| C | LiCoO₂: (104) 60 cps, (003) 50 cps |
| D | no LiCoO₂, but FeCrNi, Fe₂O₃, Fe, Li_{0.125}Co_{0.875}^{o} |
| E | no LiCoO₂, but Li₂Fe₃O₅, Ag |
| F | no LiCoO₂, but Ag, Li_{0.21}Co_{0.79}O |
| G | LiCoO₂: (003) 65 cps (104) 35 cps, also Ag, Li_{0.21}Co_{0.79}O, Li₂O |
| H | no LiCoO₂, but Li_{0.125}Co_{0.875}O |

Again it is apparent that foils ‘A’, ‘B’, and ‘C’ outperform the other foils. It are these foils that comprise a metal with a high affinity to oxygen such as aluminium. The lithium is not lost to the substrate in foils A, B and C. No aluminium oxide phases were found back in the XRD investigations. In foils D, E, F and H the phases have a lithium deficit. In E the lithium even forms a Li₂Fe₃O₅ phase with the iron oxide of the foil. Foil ‘G’ behaves intermediate to both extremes.

In a further investigation, the composition of the interface between substrate and first electrode was determined by means of X-ray Photoemission Spectroscopy (XPS) on a sample deposited on foil ‘A’. The results are represented in FIG. 2 where the abundances of Co, Al, Cr, Fe, C and O (Li was not traced) as detected are represented in atomic % in ordinate and the sputter time for pealing off the deposited layer in seconds. The oxygen binding configuration can be disentangled in XPS. The oxygen curve indicated by O(TFA1) is attributed to oxygen bound in LiCoO_{2,} while O(TFA2) is oxygen bound to Al. It is clear that predominantly an aluminium oxide layer has formed at the surface of the substrate foil in competition with a chrome oxide layer. The aluminium oxide layer is estimated to be about 100 nm thick.

The same observation was found by means of SIMS-TOF measurements on a sample deposited on foil ‘A. In addition silver was detected in the deposited layer as well as in the interface between the deposited layer and the substrate. It turns out that the intensity of the Ag peak at the interface is between 2 to 20 times higher as the Ag intensity of the bulk of the material.

The performance of the foils was also tested in a wet chemical cell. Only the first electrodes from foils A, B, C and G turned out to be useful in a battery.

Based on this a complete thin film battery was produced departing from the foil A. On the 420 nm LiCoO₂ electrode, a LiPON 1.2 μm thick electrolyte was deposited by RF sputtering. On top of this, a 500 nm Cu current collector was deposited. Hence no second electrode was deposited, and the lithium collects between the LiPON and Cu upon charging the device.

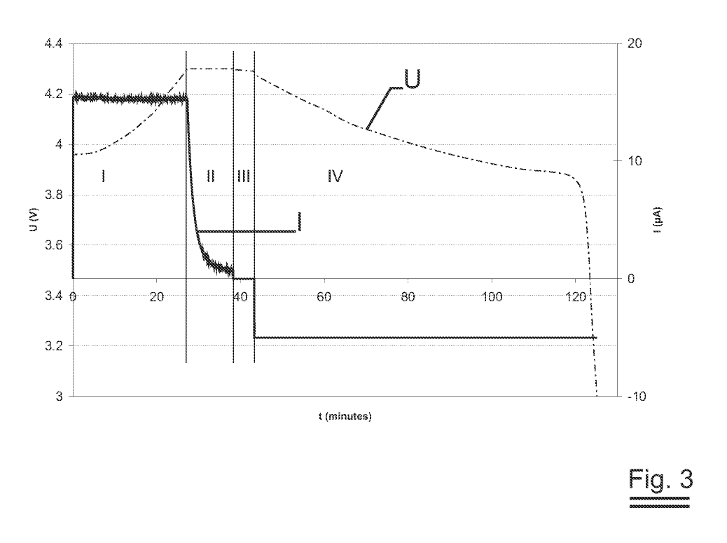

FIG. 3 shows the current I (in μA) and voltage U (in V) measured over a complete charge/discharge cycle on the device as a function of time (in minutes). The time slot indicated by ‘I’ is a constant current charging period, while the voltage was measured. Thereafter a constant voltage of 4.3 V was applied while the current was monitored. In total about 27 mC of charge was moved in the device. In region III the open cell voltage was measured. Finally (region IV) the battery was discharged at a constant current of −5 μA. It took about 80 minutes before the voltage dropped below 3.8 V. About 26 mC of charge was recovered.

1. A thin film lithium ion-switching device comprising a substrate, a first electrode covering said substrate, an electrolyte covering said first electrode an optional second electrode covering said electrolyte, and a second current collector in contact with said second electrode or covering said electrolyte, characterised in that said substrate comprises a layer useable as a first current collector made of an alloy comprising at least three metals or silicon, each of said metals or silicon having a concentration in excess of one percent by weight of which the first metal is more noble than the second metal, the second metal is more noble than the third metal or silicon, said third metal or silicon being capable of forming an oxide scale that is a diffusion barrier to lithium.

2. The device according to claim 1 wherein said first metal is one out of the group of Fe, Ni, Sn, Cu, said second metal is one out of the group of Cr, Zn, Fe, said third metal is one out of the group of Mg, Al, Zn or is Si.

3. The device according to claim 2 wherein the first metal is Fe, the second metal is Cr, and the third metal is Al.

4. The device according to claim 3 wherein the amount of Al is at least 3% by weight.

5. The device according to claim 4 wherein the amount of Al is at least 5% by weight.

6. The device according to claim 2 wherein the first metal is Ni, the second metal is Cr, and the third metal is Al.

7. The device according to claim 1 wherein said layer further comprises one or more metals out of the group of Y, Hf, Zr, Ce and La in concentrations of at least 0.02 percent by weight for improving the adhesion of said oxide scale to said layer.

8. The device according to claim 1 wherein said layer further comprises one out of the group comprising Ag, Bi, Zn, Sn and Sb in a detectable amount of less than 0.5% by weight at the interface between said layer and said first electrode material.

9. The device according to claim 1 wherein said first electrode material is one out of the group of lithium cobaltate, lithium manganate, lithium nickelate, lithium nickel manganese oxide, lithium nickel cobalt manganese oxide, lithium nickel cobalt oxide, lithium vanadium oxide, lithium iron phosphate, lithium vanadium phosphate, lithium cobalt vanadium oxide, lithium titanium oxide, lithium silicon tin oxynitride.

10. The device according to claim 1 wherein the electrolyte is one out of the group of lithium phosphate, lithium phosphorus oxynitride, lithium niobate, lithium niobium oxynitride, lithium tantalate, lithium tantalum oxynitride, lithium tantalum niobium oxynitride, lithium silicate, lithium aluminum silicate, lithium silicon oxynitride, and lithium silicon phosphorus oxynitride, lithium aluminum fluoride, lithium boron oxynitride, lithium boron phosphorus oxynitride, lithium boron vanadium oxide, lithium boron selenium oxide, lithium silicon phosphorous oxysulfide, lithium silicon phosphate, lanthanum lithium titanate, lanthanum lithium tatantalate, lanthanum lithium niobate, lithium titanium aluminium phosphate, lithium aluminium germanium phosphate, lithium aluminium yttrium phosphate, a lithium silicosulfide, a lithium borosulfide, a lithium aluminosulfide, a lithium phosphosulfide.

11. The device according to claim 1 wherein said second electrode is one out of the group of lithium, carbon, graphite, tin, silicon, silicon tin, aluminium, silicon tin aluminium, tin antimony, silicon carbon, silicon cobalt carbon, silicon titanium nitride, silicon titanium boride, magnesium silicon, lithium cobaltate, lithium manganate, lithium nickelate, lithium nickel manganese oxide, lithium nickel cobalt manganese oxide, lithium nickel cobalt oxide, lithium vanadium oxide, lithium iron phosphate, lithium vanadium phosphate, lithium cobalt vanadium oxide, lithium titanium oxide, lithium silicon tin oxynitride, vanadium oxide, titanium sulfate.

12. The device according to claim 1 wherein said second electrode is absent and where said second current collector is one out of the group of Cu, Ti, Cr, Ni, Au, Pt, Pd, Ru or any other metal that does not form an alloy with lithium.
